(19) United States
(12) Patent Application Publication
(10) Pub. No.: US 2025/0362136 A1
(43) Pub. Date: Nov. 27, 2025

(54) METHOD AND SYSTEM FOR ADAPTIVELY IDENTIFYING AN OPTIMAL ROUTE

(71) Applicant: GRABTAXI HOLDINGS PTE. LTD., Singapore (SG)

(72) Inventors: Yaohui LI, Singapore (SG); Chunda DING, Chaoyang District, Beijing (CN); Xiaoning WANG, Singapore (SG)

(21) Appl. No.: 18/873,446

(22) PCT Filed: May 30, 2023
(86) PCT No.: PCT/SG2023/050385

§ 371 Date: Dec. 10, 2024

(30) Foreign Application Priority Data
Jun. 17, 2022 (WO) PCT/CN2022/099517

(51) Int. Cl. G01C 21/34; G06Q 10/047; G06Q 50/47

(52) U.S. Cl. CPC G01C 21/3438; G06Q 10/047; G06Q 50/47

(57) ABSTRACT

The present disclosure provides methods and systems for adaptively identifying an optimal route. In some examples, there is provided a method comprising: determining, by a processor, one or more pick up points based on historical data relating to a starting location, the starting location being one that is indicated in a request for a ride from the starting location to a destination location; determining, by the processor, one or more routes between each of the determined one or more pick up points and the destination location indicated in the ride request; and adaptively identifying, by the processor, an optimal route from the one or more routes based on at least one of a cheapest route, fastest route, shortest route and shortest walking distance.

### FIELD OF INVENTION

The present disclosure relates broadly, but not exclusively, to methods and systems for adaptively identifying an optimal route.

### BACKGROUND

Ride-hailing platform applications typically require a user to select a specific pick-up point and drop-off point that they want to go to. In more advanced implementations, some ride-hailing platform applications may predict a pick-up point based on the user's current location.

Users of ride-hailing platforms generally want to get to their destination faster or at the lowest possible cost, but may be unaware of the options available. Price is typically the most prominent factor that most users look out for and users may manually compare prices of different pick-up points based on their familiarity of the area. However, doing this comparison for all possible pick-up and drop-off point pairs (e.g. to find an optimal pair in which the user is picked up by a driver of the ride at a pick-up point that is reasonably close to a current location of the user and then dropped off at a drop-off point that is reasonably close to the destination) would be infeasible to do manually.

A need therefore exists to provide methods and systems that seek to overcome or at least minimize the above mentioned challenges.

### SUMMARY

According to a first aspect of the present disclosure, there is provided a method for adaptively identifying an optimal route, the method comprising: determining, by a processor, one or more pick up points based on historical data relating to a starting location, the starting location being one that is indicated in a request for a ride from the starting location to a destination location; determining, by the processor, one or more routes between each of the determined one or more pick up points and the destination location indicated in the ride request; and adaptively identifying, by the processor, an optimal route from the one or more routes based on at least one of a cheapest route, fastest route, shortest route and shortest walking distance.

According to a second aspect of the present disclosure, there is provided a system for adaptively identifying an optimal route, comprising: at least one processor; and at least one memory including computer program code; the at least one memory and the computer program code configured to, with the at least one processor, cause the system at least to: determine one or more pick up points based on historical data relating to a starting location, the starting location being one that is indicated in a request for a ride from the starting location to a destination location; determine one or more routes between each of the determined one or more pick up points and the destination location indicated in the ride request; and adaptively identify an optimal route from the one or more routes based on at least one of a cheapest route, fastest route, shortest route and shortest walking distance.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 illustrates a system for adaptively identifying an optimal route according to various embodiments of the present disclosure.

FIG. 2 is a schematic diagram of a route server, according to various embodiments of the present disclosure.

FIGS. 3A-F depict example illustrations of issues relating to ride-hailing.

FIGS. 4A-B depict an example illustration of a user booking flow according to various embodiments.

FIG. 5 depicts an example illustration of a flowchart for adaptively identifying an optimal route according to various embodiments.

FIG. 6 depicts an example illustration of a system that may be implemented for adaptively identifying an optimal route according to various embodiments.

FIG. 7 illustrates an example flow diagram of a method for adaptively identifying an optimal route according to various embodiments.

FIG. 8A is a schematic block diagram of a general purpose computer system upon which the route server of FIG. 2 can be practiced.

FIG. 8B is a schematic block diagram of a general purpose computer system upon which a combined transaction processing and route server of FIG. 1 can be practiced.

FIG. 9 shows an example of a computing device to realize the transaction processing server shown in FIG. 1.

FIG. 10 shows an example of a computing device to realize the route server shown in FIG. 1.

FIG. 11 shows an example of a computing device to realize a combined transaction processing and route server shown in FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

### Terms Description

A platform refers to a set of technologies that is used as a base for facilitating exchanges between two or more interdependent servers, entities and/or devices, for example between a requestor device (of a product or service) and a provider device (of the product or service). For example, a platform may offer a service offered by a provider such as a ride, delivery, online shopping, insurance, and other similar services to a requestor. The requestor can typically access the platform via a website, an application, or other similar methods.

A place of interest (POI) is a place or location that a user may indicate or search for in a transport or delivery booking service. The POI may be a place at which the user may be interested in going or delivering something. It may also be a location at which the user wants to be picked up by a driver (e.g. a pick up point) or at which a delivery person is to retrieve an item for the user. There may be various drop off points (e.g. places where a user may alight after a ride, or deliver an item) or pick up points (e.g. places where a user may board a vehicle or receive an item that is to be delivered) associated with a POI which a user may be able to indicate or search in a transport or delivery booking service. In a request for a ride or delivery that may be sent from the user to the transport or delivery booking service, the POI at which the user wants to begin the ride or start the delivery may be indicated as a starting location, while the POI at which the user may be interested in going or delivering something may be indicated as a destination location. In cases where there are one or more pick up points that are in proximity with a POI, each of the one or more pick up points may be within walking distance from the POI, or at the POI. Likewise, in cases where there are one or more drop off points that are in proximity with a POI, the one or more drop off points may be within walking distance from the POI, or at the POI.

A request for a ride may originate from a requestor and transmitted from a requestor device to a server or device associated with the platform, and may include location information such as a starting location at which the requested ride should start and a destination location at which the requested ride should end. The starting location may be a current location of the requestor based on, for example, GPS location of the requestor device, or it can be another location that is input by the requestor in the ride request. The starting location may have one or more pick up points from which the requestor can be picked up by a provider for the ride. The one or more pick up points May be determined based on proximity to the starting location such that it may require the requestor to walk a certain distance (e.g. within a walking distance) from the starting location to a pick up point. In some embodiments, the starting location itself can be the pick up point. The destination location may have one or more drop off points at which the requestor can be dropped off by the provider for the ride. The one or more drop off points are typically determined based on proximity to the destination location such that it may require the requestor to walk a certain distance (e.g. within a walking distance) from the drop off point to the destination location. In some embodiments, the destination location itself can be the drop off point. One or more routes for the requested ride may be determined based on the starting location (or the one or more pick up points) and the destination location (or the one or more drop off points), and an optimal route may be identified based on a criteria. The criteria may be at least one of a cheapest route, fastest route, shortest route and shortest walking distance, and may be set based on a predicted user preference of the requestor by the platform, or set by the requestor.

In at least some embodiments, a user may be any suitable type of entity, which may include a person, a consumer looking to purchase a product or service via a transaction processing server, a seller or merchant looking to sell a product or service via the transaction processing server, a motorcycle driver or pillion rider in a case of the user looking to book or provide a motorcycle ride via the transaction processing server, a car driver or passenger in a case of the user looking to book or provide a car ride via the transaction processing server, and other similar entity. A user who is registered to the transaction processing server will be called a registered user. A user who is not registered to the transaction processing server will be called a non-registered user. The term user will be used to collectively refer to both registered and non-registered users. A user may interchangeably be referred to as a requestor (e.g. a person who requests for a product or service) or a provider (e.g. a person who provides the requested product or service to the requestor).

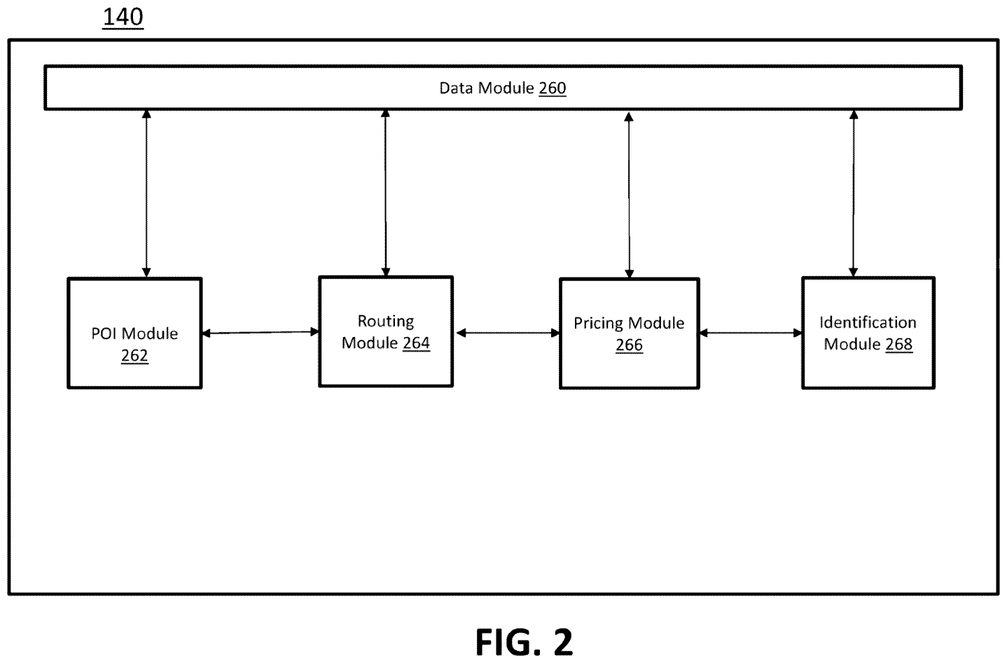

In at least some embodiments, a route server is a server that hosts software application programs for adaptively identifying an optimal route. The route server may be implemented as shown in schematic diagram 200 of FIG. 2 for adaptively identifying an optimal route.

In at least some embodiments, a transaction processing server is a server that hosts software application programs for processing payment transactions for, for example, a travel-ordination request, purchasing of a good or service by a user, and other similar services. The transaction processing server communicates with any other servers (e.g., a route server) concerning processing payment transactions relating to the purchasing of the good or service, such as a travel co-ordination request (which may be referred to interchangeably as a request for a ride). For example, data relating to a request message such as a request for a ride (e.g. date, time, a starting location, a destination location, and other similar data) may be provided to the route server and processed to locate drivers (e.g. ride providers) that are in proximity to the starting location. The transaction processing server may use a variety of different protocols and procedures in order to process the payment and/or travel co-ordination requests.

Transactions that may be performed via a transaction processing server include product or service purchases, credit purchases, debit transactions, fund transfers, account withdrawals, etc. Transaction processing servers may be configured to process transactions via cash-substitutes, which may include payment cards, letters of credit, checks, payment accounts, etc.

In at least some embodiments, the transaction processing server is usually managed by a service provider that may be an entity (e.g. a company or organization) which operates to process transaction requests and/or travel co-ordination requests e.g. pair a provider of a travel co-ordination request to a requestor of the travel co-ordination request. The transaction processing server may include one or more computing devices that are used for processing transaction requests and/or travel co-ordination requests.

In at least some embodiments, a transaction account is an account of a user who is registered at a transaction processing server. The user can be a customer, a merchant providing a product for sale on a platform and/or for onboarding the platform, a hail provider (e.g., a driver), or any third parties (e.g., a courier) who want to use the transaction processing server. In certain circumstances, the transaction account is not required to use the transaction processing server. A transaction account includes details (e.g., name, address, vehicle, face image, etc.) of a user. The transaction processing server manages the transaction.

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “identifying”, “determining”, “associating”, “selecting”, “calculating”, “processing”, “storing”, “indicating”, or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

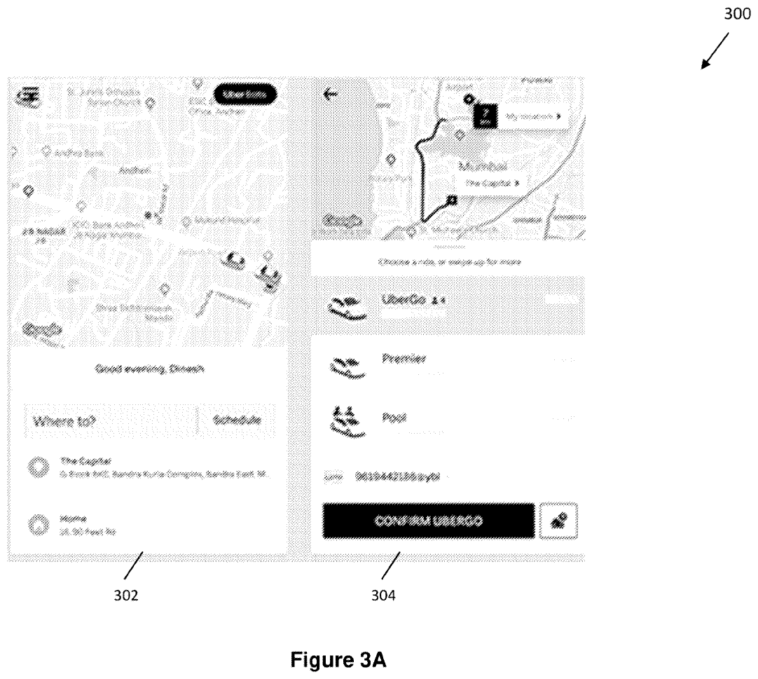

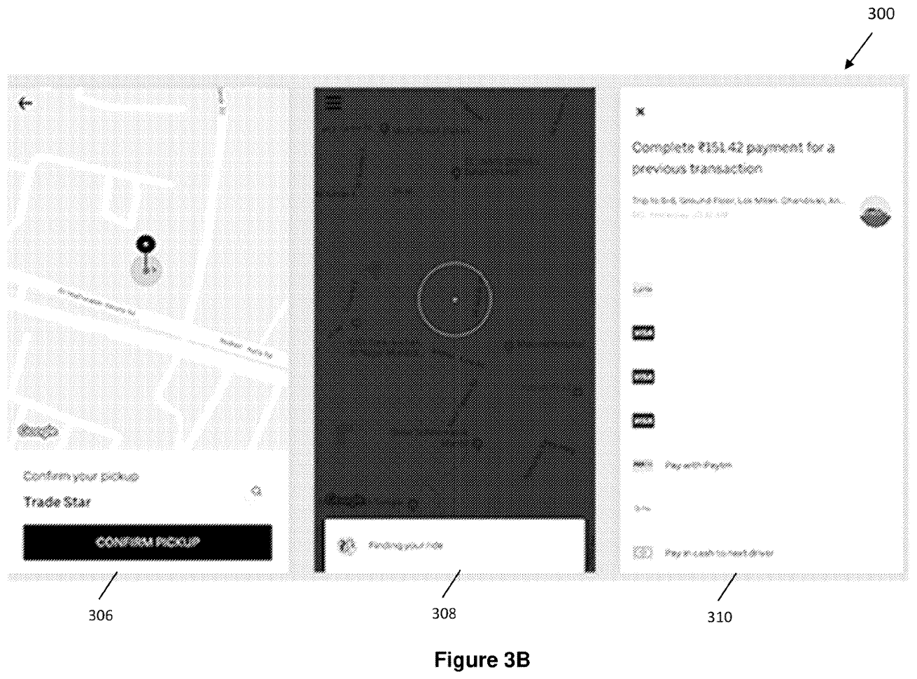

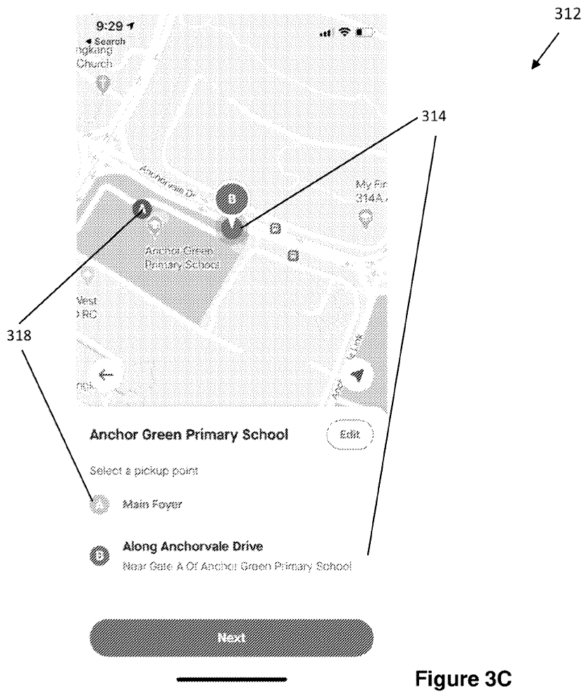

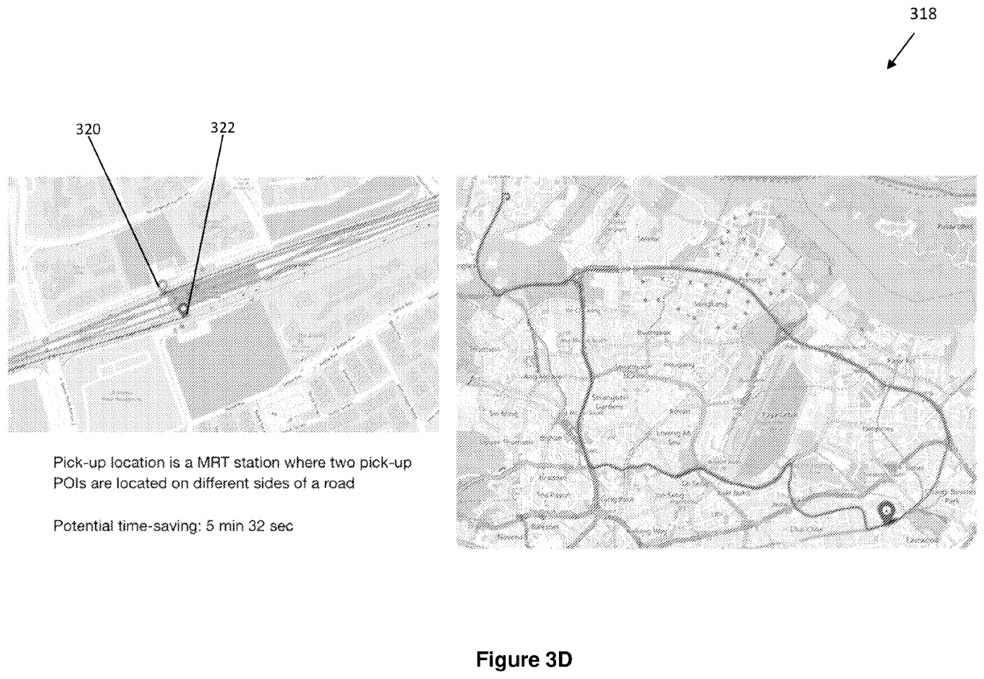

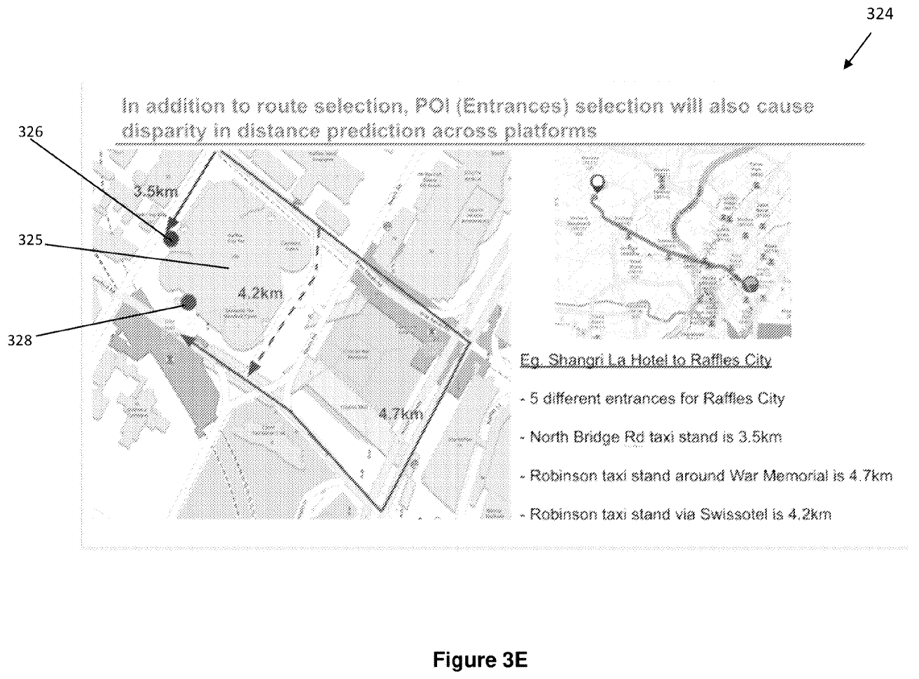

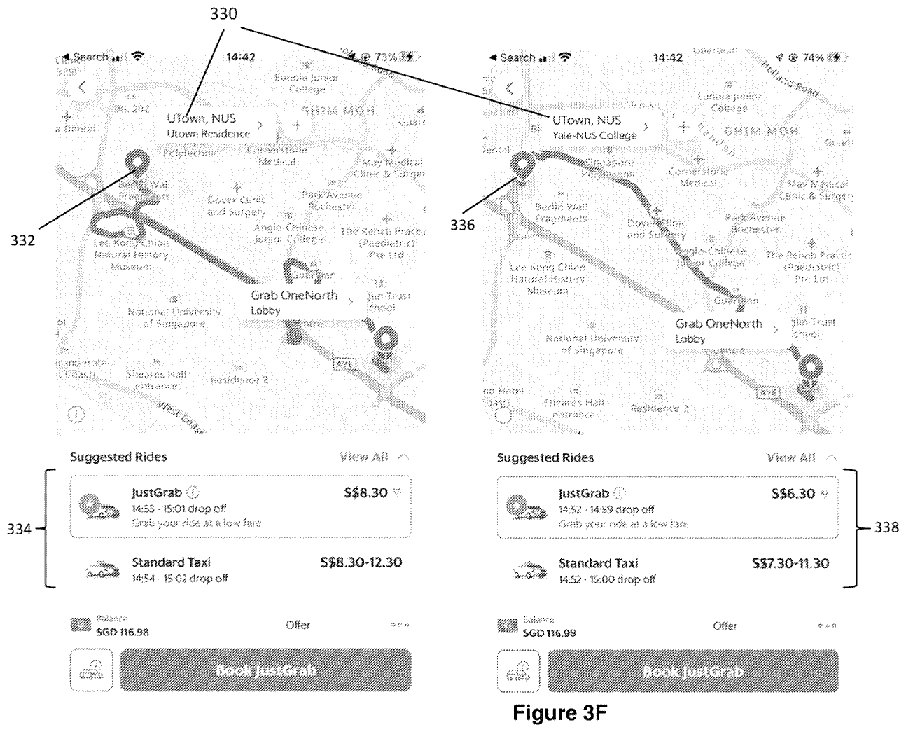

Referring to FIGS. 3A and 3B, a ride booking process typically involves selecting a starting location and a destination location in an example menu 302, selecting a desired type of transport configuration in an example menu 304, confirming a pick up point for the ride request in an example menu 306, waiting for the application to find a driver for the requested ride as shown in example menu 308, and completing payment for the ride in example menu 310 in a case of, for example, a post-paid ride.

In some ride hailing applications, pick up points may be suggested based on the starting location indicated in the ride request. For example, referring to an example menu 312 in FIG. 3C, two pick up points 314 and 316 are suggested to a user based on a starting location. Depending on the pick up points, the route that is planned for the ride may be different. For example, referring to illustration 318 of FIG. 3D, pick up points 320 and 322 are on opposite sides of a road, therefore resulting in different routes for each pick up point with different distances, travel times, ride prices and distances from the starting location indicated in the ride request. Pairing the pick up and drop off locations is particularly important as pick ups from different side of the road can lead to very different travel times. In this example, a user may get picked up from different sides of the road. If the user wishes to head towards a location that is to the left of the map of illustration 318, getting picked up from pick-up point 320 will lead to shorter travelling time as the driver does not need to make a U-turn. The reverse is also applicable when selecting pick-up point 322 and travelling towards the right of the map of illustration 318. This difference can result in less or more travel time for the user depending on the selected pick up point.

This is also applicable for different drop off points for a destination location. In example illustration 324 of FIG. 3E, drop off points 326 and 328 are associated with different entrances for a destination location 325, which result in different routes for each drop off point with different distances, travel times, ride prices, and may also result in different distances between a drop off point and the destination location indicated in the ride request. Many buildings and venues typically have this characteristic where different pick up/drop off points of the building may lead to more efficient travel to, for example, different parts of the city. For example, picking an arbitrary pick up point for a ride to the destination location 325 may have more than 1 km of distance differences among the determined routes between the pick up point and each different entrance or drop off point of the destination location 325.

Further, example illustration of FIG. 3E shows that indicating a different pick up point for a same POI may result in a different route with a different price. For example, selecting pick up point 332 of POI 330 (e.g. UTown, NUS) results in a trip price of between $8.30 to $12.30 (see reference 334), while selecting pick up point 336 of the same POI 330 results in a trip price of between $6.30 to $11.30 (see reference 338).

In the present disclosure, a method is proposed where one or more pick up and/or drop off points may be suggested based on a user's inputs in a request for a ride, and one or more routes may be determined and indicated to the user based on each of the one or more pick up and/or drop off points. The user may be able to select from the one or more pick up and/or drop off points as well as the one or more routes based on at least one of a cheapest route, fastest route, shortest route and shortest walking distance. This advantageously enables the user to be better informed of all possible options for going to a desired destination, and enables the user to get to the desired destination in the fastest and/or cheapest way possible depending on the selected route.

To support the operation mentioned above, the closest pick up and/or drop off points that are feasible for the user to get to may be determined based from a starting location. This may include the use of walking maps to estimate the walking time required for travelling to each of the one or more pick up points from the starting location, and/or from each of the one or more drop off points to a destination location. The starting location and destination location may be indicated in a request for a ride by the user. In an implementation, the starting location may be a current location of the user.

In a next step, one or more routes may be determined for each pair of pick up and drop off points. A corresponding price and distance for each of the one or more routes may also be determined. These pairwise combinations may be ranked based on criteria such as cost savings, travel time, walking time, ease of walking, and other similar criteria. The ranked list of suggested routes may then be provided to the user for final selection.

By automating the above process, information for the user to make the trade-off between price, time and walking can be presented in a way that would advantageously maximize both revenue for the ride-hailing platform and savings for the users, depending on the user selection that may provide a trade-off between paying more for the driver providing the ride to pick up the user at the nearest possible location without requiring any walking, or walking to a pick-up point but thereafter reaching the destination location via a faster and cheaper route.

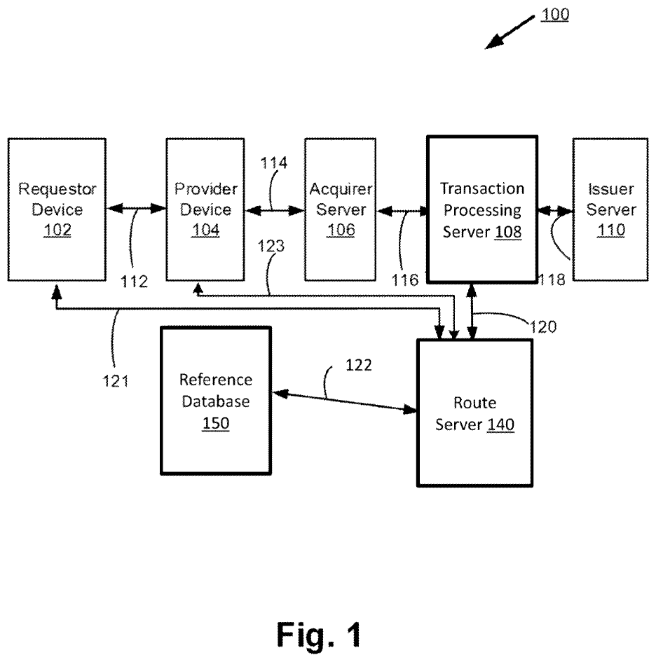

FIG. 1 illustrates a block diagram of an example system 100 for adaptively identifying an optimal route. In some embodiments, the system 100 enables a payment transaction for a good or service, and/or a request for a ride or delivery of a physical item (e.g. one or more food items or a parcel) between a requestor and a provider.

The system 100 comprises a requestor device 102, a provider device 104, an acquirer server 106, a transaction processing server 108, an issuer server 110, a route server 140 and a reference database 150.

The requestor device 102 is in communication with a provider device 104 via a connection 112, and may be associated with a user. The connection 112 may be wireless (e.g., via NFC communication, Bluetooth, etc.) or over a network (e.g., the Internet). The requestor device 102 is also in communication with the route server 140 via a connection 121, wherein the route server 140 may be configured to receive a request for a ride indicating information relating to a starting location and a destination location from the requestor device 102. The connection 121 may be via a network (e.g., the Internet). The requestor device 102 may also be connected to a cloud that facilitates the system 100 for adaptively identifying an optimal route. For example, the requestor device 102 can send a signal or data to the cloud directly via a wireless connection (e.g., via NFC communication, Bluetooth, etc.) or over a network (e.g., the Internet).

The provider device 104 is in communication with the requestor device 102 as described above, usually via the transaction processing server 108, and may be associated with a provider of a ride (e.g. a driver responding to the request for the ride). The provider device 104 is, in turn, in communication with an acquirer server 106 via a connection 114. The provider device 104 is also in communication with the route server 140 via a connection 123, wherein the route server 140 may be configured to receive location information of the provider device 104, for example to determine whether the provider device 104 is in proximity to the starting location and whether to offer the ride request to the provider device 104. The connections 114 and 123 may be via a network (e.g., the Internet). The provider device 104 may also be connected to a cloud that facilitates the system 100 for adaptively identifying an optimal route. For example, the provider device 104 can send a signal or data to the cloud directly via a wireless connection (e.g., via NFC communication, Bluetooth, etc.) or over a network (e.g., the Internet).

The acquirer server 106, in turn, is in communication with the transaction processing server 108 via a connection 116. The transaction processing server 108, in turn, is in communication with an issuer server 110 via a connection 118. The connections 116 and 118 may be via a network (e.g., the Internet).

The transaction processing server 108 is further in communication with the route server 140 via a connection 120. The connection 120 may be over a network (e.g., a local area network, a wide area network, the Internet, etc.). In one arrangement, the transaction processing server 108 and the route server 140 are combined and the connection 120 may be an interconnected bus.

The route server 140, in turn, is in communication with the reference database 150 via respective connection 122. The connection 122 may be over a network (e.g., the Internet). The route server 140 may also be connected to a cloud that facilitates the system 100 for adaptively identifying an optimal route. For example, the route server 140 can send a signal or data to the cloud directly via a wireless connection (e.g., via NFC communication, Bluetooth, etc.) or over a network (e.g., the Internet).

The reference database 150 may comprise data that is utilized by the route server 140 for adaptively identifying an optimal route. For example, historical data relating to the starting location and destination location may be stored in the reference database 150. The historical data may indicate a plurality of POIs, which may comprise one or more pick up points for the starting location and one or more drop off points for the destination location. The historical data may further indicate location information for each of the one or more pick up points and drop off points. Data relating to user information such as selections during past and present transactions, user preferences, and other similar data may also be stored in the reference database 150. Further, data relating to pricing information (e.g. data that is utilized for calculating a price for each route that may be determined by the route server 140) may also be stored in the reference database 150. Furthermore, data relating to maps (e.g. Karta Map™) may also be stored in the reference database 150. In an implementation, the reference database 150 may be combined with the route server 140. In an example, the reference database 150 may be managed by an external entity.

The route server 140 may be configured to determine one or more pick up points based on historical data relating to a starting location, the starting location being one that is indicated in a request for a ride from the starting location to a destination location. The route server 140 may then be configured to determine one or more routes between each of the determined one or more pick up points and the destination location indicated in the ride request, and adaptively identify an optimal route from the one or more routes based on at least one of a cheapest route, fastest route, shortest route and shortest walking distance.

The historical data may indicate a plurality of pick up points and location information for each of the plurality of pick up points, and determining the one or more pick up points further comprises selecting, from the plurality of pick up points, one or more pick up points that are in proximity to the starting location based on the location information.

In an implementation, there may be more than one reference databases, in which the route server 140 may be configured to determine which database to use for each step during processing of a request for a ride. Alternatively, one or more modules may store the above-mentioned data instead of the reference database 150, wherein the module may be integrated as part of the route server 140 or external from the route server 140.

In the illustrative embodiment, each of the devices 102, 104, and the servers 106, 108, 110, 140, and/or reference database 150 provides an interface to enable communication with other connected devices 102, 104 and/or servers 106, 108, 110, 140, and/or reference database 150. Such communication is facilitated by an application programming interface (“API”). Such APls may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for the requestor device 102 to send data relating to a selection of a route for a requested ride, and for the provider device 104 to send data relating to acceptance or rejection of a ride request, in response to an enquiry shown on the GUI running on the respective API.

Use of the term ‘server’ herein can mean a single computing device or a plurality of interconnected computing devices which operate together to perform a particular function. That is, the server may be contained within a single hardware unit or be distributed among several or many different hardware units.

The route server 140 is associated with an entity (e.g. a company or organization or moderator of the service). In one arrangement, the route server 140 is owned and operated by the entity operating the transaction processing server 108. In such an arrangement, the route server 140 may be implemented as a part (e.g., a computer program module, a computing device, etc.) of the transaction processing server 108.

The transaction processing server 108 may also be configured to manage the registration of users. A registered user has a transaction account (see the discussion above) which includes details of the user. The registration step is called on-boarding. A user may use either the requestor device 102 or the provider device 104 to perform on-boarding to the transaction processing server 108.

It may not be necessary to have a transaction account at the transaction processing server 108 to access the functionalities of the transaction processing server 108. However, there are functions that are available to a registered user. These additional functions will be discussed below.

The on-boarding process for a user is performed by the user through one of the requestor device 102 or the provider device 104. In one arrangement, the user downloads an app (which includes the API to interact with the transaction processing server 108) to the requestor device 102 or the provider device 104. In another arrangement, the user accesses a website (which includes the API to interact with the transaction processing server 108) on the requestor device 102 or the provider device 104. The user is then able to interact with the route server 140. The user may be a requestor or a provider associated with the requestor device 102 or the provider device 104, respectively.

Details of the registration may include, for example, name of the user, address of the user, emergency contact, blood type or other healthcare information, next-of-kin contact, permissions to retrieve data and information from the requestor device 102 and/or the provider device 104 for adaptively identifying an optimal route, such as permission to retrieve location information of the requestor device 102 and/or the provider device 104. Alternatively, another mobile device may be selected instead of the requestor device 102 and/or the provider device 104 for retrieving the data. Once on-boarded, the user would have a transaction account that stores all the details.

The requestor device 102 is associated with a customer (or requestor) who is a party to a transaction that occurs between the requestor device 102 and the provider device 104, or between the requestor device 102 and the route server 140. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may be associated with a user who initiates a request for a ride.

The requestor device 102 includes transaction credentials (e.g., a payment account) of a requestor to enable the requestor device 102 to be a party to a payment transaction. If the requestor has a transaction account, the transaction account may also be included (i.e., stored) in the requestor device 102. For example, a mobile device (which is a requestor device 102) may have the transaction account of the customer stored in the mobile device.

In one example arrangement, the requestor device 102 is a computing device in a watch or similar wearable and is fitted with a wireless communications interface (e.g., a NFC interface). The requestor device 102 can then electronically communicate with the provider device 104 regarding a transaction request. The customer uses the watch or similar wearable to make request regarding the transaction request by pressing a button on the watch or wearable.

The provider device 104 is associated with a provider who is also a party to the transaction request that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may be associated with a provider of a ride (e.g. a driver responding to the request for the ride).

Hereinafter, the term “provider” refers to a service provider and any third party associated with providing a product or service for purchase, or a travel or ride or delivery service via the provider device 104. Therefore, the transaction account of a provider refers to both the transaction account of a provider and the transaction account of a third party (e.g., a travel co-ordinator or merchant) associated with the provider.

If the provider has a transaction account, the transaction account may also be included (i.e., stored) in the provider device 104. For example, a mobile device (which is a provider device 104) may have the transaction account of the provider stored in the mobile device.

In one example arrangement, the provider device 104 is a computing device in a watch or similar wearable and is fitted with a wireless communications interface (e.g., a NFC interface). The provider device 104 can then electronically communicate with the requestor to make request regarding the transaction request by pressing a button on the watch or wearable.

The acquirer server 106 is associated with an acquirer who may be an entity (e.g. a company or organization) which issues (e.g. establishes, manages, administers) a payment account (e.g. a financial bank account) of a merchant. Examples of the acquirer include a bank and/or other financial institution. As discussed above, the acquirer server 106 may include one or more computing devices that are used to establish communication with another server (e.g., the transaction processing server 108) by exchanging messages with and/or passing information to the other server. The acquirer server 106 forwards the payment transaction relating to a transaction request or a request for a ride to the transaction processing server 108.

The transaction processing server 108 is configured to process processes relating to a transaction account by, for example, forwarding data and information associated with the transaction to the other servers in the system 100 such as the route server 140. In an example, the transaction processing server 108 may, instead of the requestor device 102, transmit data relating to a request message such as a request for a ride (e.g. date, time, a starting location, a destination location, and other similar data) to the route server 104. The transaction processing server 108 may use a variety of different protocols and procedures in order to process the payment and/or travel co-ordination requests. It will be appreciated that payment for a transaction may be made via a variety of methods such as credit cards, debit cards, digital wallets, buy-first pay-later schemes, and other similar payment methods.

The issuer server 110 is associated with an issuer and may include one or more computing devices that are used to perform a payment transaction. The issuer may be an entity (e.g. a company or organization) which issues (e.g. establishes, manages, administers) a transaction credential or a payment account (e.g. a financial bank account) associated with the owner of the requestor device 102. As discussed above, the issuer server 110 may include one or more computing devices that are used to establish communication with another server (e.g., the transaction processing server 108) by exchanging messages with and/or passing information to the other server.

The reference database 150 is a database or server associated with an entity (e.g. a company or organization) which manages (e.g. establishes, administers) data relating to users, transactions, products, services, and other similar data, for example relating to the entity. In an arrangement, the reference database 150 may comprise data that is utilized by the route server 140 for adaptively identifying an optimal route. For example, historical data relating to the starting location and destination location may be stored in the reference database 150. The historical data may indicate a plurality of POIs, which may comprise one or more pick up points for the starting location and one or more drop off points for the destination location. The historical data may further indicate location information for each of the one or more pick up points and drop off points. Data relating to user information such as selections during past and present transactions, user preferences, and other similar data may also be stored in the reference database 150. Further, data relating to pricing information (e.g. data that is utilized for calculating a price for each route that may be determined by the route server 140) may also be stored in the reference database 150. Furthermore, data relating to maps (e.g. Karta Map™) may also be stored in the reference database 150. In an implementation, the reference database 150 may be combined with the route server 140. In an example, the reference database 150 may be managed by an external entity.

Advantageously, the system 100 advantageously enables a user to be better informed of all possible options for going to a desired destination, and enables the user to get to the desired destination in the fastest and/or cheapest way possible depending on the selected route. Further, information for the user to make the trade-off between price, time and walking can be presented in a way that would advantageously maximize both revenue for the ride-hailing platform and savings for the users, depending on the user selection that may provide a trade-off between paying more for the driver providing the ride to pick up the user at the nearest possible location without requiring any walking, or walking to a pick-up point but thereafter reaching the destination location via a faster and cheaper route.

FIG. 2 illustrates a schematic diagram of an example route server 140 according to various embodiments. The route server 140 may comprise a data module 260 configured to receive data and information from the requestor device 102, provider device 104, transaction processing server 108, reference database 150, a cloud and other sources of information to adaptively identify an optimal route by the route server 140. For example, the data module 260 may be configured to receive data and information required for processing a request for a ride and adaptively identifying an optimal route from the requestor device 102, the provider device 104, transaction processing server 108, reference database 150, and/or other sources of information. The data module 260 may be further configured to send information relating to data retrieved in response to the request for a ride to the requestor device 102, the provider device 104, the transaction processing server 108, or other destinations where the information is required.

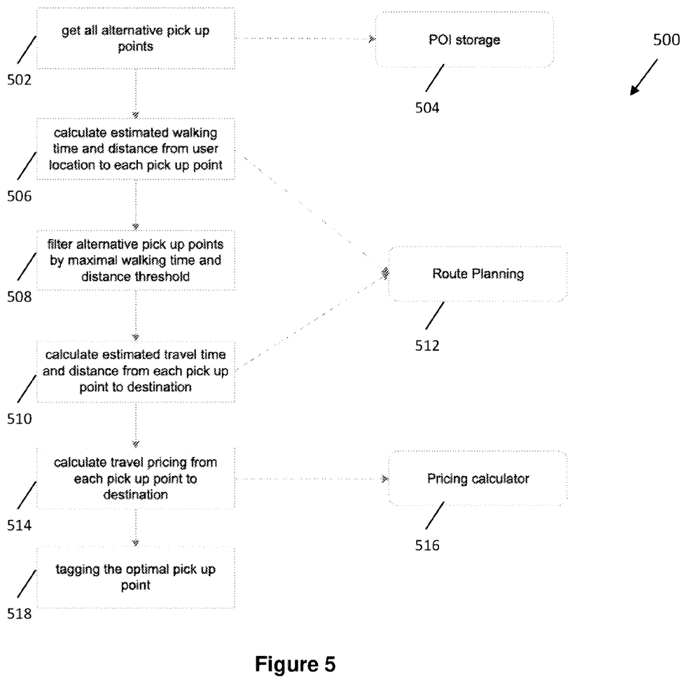

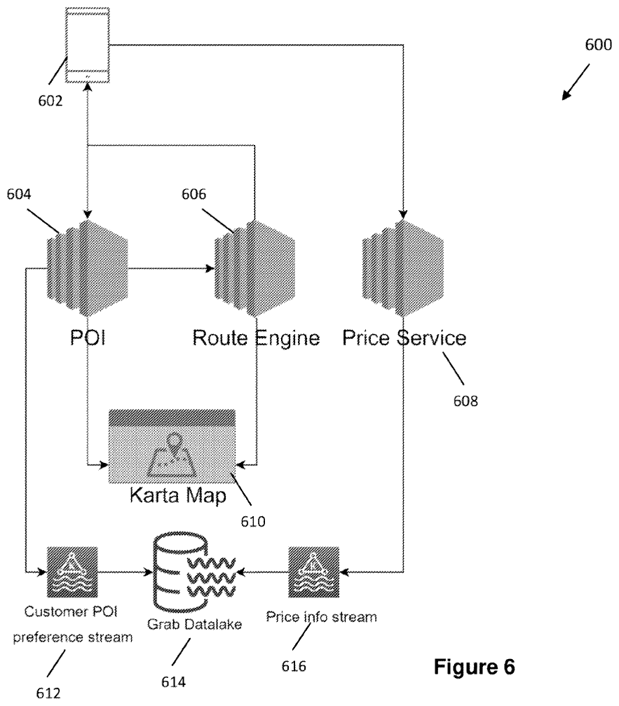

The route server 140 may comprise a POI module 262 that is configured for determining one or more pick up points based on historical data relating to a starting location, the starting location being one that is indicated in a request for a ride from the starting location to a destination location. The POI determination process is further explained in FIGS. 5-6.

The route server 140 may also comprise a routing module 264 that is configured for determining one or more routes between each of the determined one or more pick up points and the destination location indicated in the ride request. The route determination process is further explained in FIGS. 5-6.

The route server 140 may also comprise a pricing module 266 that is configured for calculating an estimated price for a ride from each of the one or more pick up points to the destination location. The route server 140 may also comprise an identification module 268 that is configured for adaptively identifying an optimal route from the one or more routes based on at least one of a cheapest route, fastest route, shortest route and shortest walking distance. The calculation and identification processes are further explained in FIGS. 5-6.

In an implementation, the historical data may be stored in the reference database 150. The historical data may indicate a plurality of pick up points and location information for each of the plurality of pick up points, and the POI module 262 may be further configured to select, from the plurality of pick up points, one or more pick up points that are in proximity to the starting location based on the location information.

In an implementation, determining the one or more routes by the routing module 264 may further comprise calculating a first set of estimated time and distance for walking from the starting location to each of the one or more pick up points, and a second set of estimated time and distance for a ride from each of the one or more pick up points to the destination location.

In an implementation, the historical data may further indicate a plurality of drop off points and location information for each of the plurality of drop off points, and the POI module 262 may be further configured to determine one or more drop off points that are in proximity to the destination location based on the location information. The routing module 264 may be further configured to determine the one or more routes comprising one or more routes between each of the determined one or more pick up points and each of the one or more determined drop off points, and calculate the second set of estimated time and distance based on a ride from each of the one or more pick up points to each of the one or more determined drop off points.

In an implementation, identifying an optimal route by the identification module 268 may further comprise identifying a route from the one or more routes with a shortest time or distance as the optimal route based on the first and/or second sets of estimated times and distances.

In an implementation, determining the one or more routes by the routing module 264 may further comprise calculating a third set of estimated time and distance for walking from each of the one or more drop off points to the destination location, and identifying an optimal route by the identification module 268 may further comprise identifying a route from the one or more routes with a shortest time or distance as the optimal route based on the first, second and/or third sets of estimated times and distances.

In an implementation, determining the one or more routes by the routing module 264 may further comprise calculating an estimated price for a ride from each of the one or more pick up points to the destination location by the pricing module 266, and identifying an optimal route by the identification module 268 may further comprise identifying a route from the one or more routes with a cheapest price as the optimal route based on the estimated prices.

Each of the data module 260, POI module 262, routing module 264, pricing module 266 and identification module 268 may further be in communication with a processing module (not shown) of the route server 140, for example for coordination of respective tasks and functions during the process. The data module 260 may be further configured to communicate with and store data and information for each of the processing module, POI module 262, routing module 264, pricing module 266 and identification module 268. Alternatively, all the tasks and functions required for adaptively identifying an optimal route may be performed by a single processor of the routing server 140.

In the present disclosure, the proposed solution may comprise determining the closest pick up and drop off points that are feasible for a user to get to from a starting location. The starting location may be a current location of the user that is based on GPS, or another location that is input by the user in a ride request. This may include the use of walking maps to estimate the walking time required from the starting location to different pick up points, or from the drop off point to the user's original intended destination e.g. a destination location input by the user in the ride request. Corresponding prices for each pair of pick up and drop off points may be calculated, and these pairwise combinations may be ranked based on criteria such as cost savings, travel time, walking time, ease of walking, and other similar criteria. Based on these combinations, a ranked list of suggestions may be provided to the user for final selection.

By automating the above process, the information for the user to make the trade-off between price, time and walking distance can be presented in a way that would maximize both revenue for the ride-hailing platform and savings for the user, depending on the user selection that trades-off between paying more for the car to come to them or walking to get to their destination faster and/or at a cheaper rate.

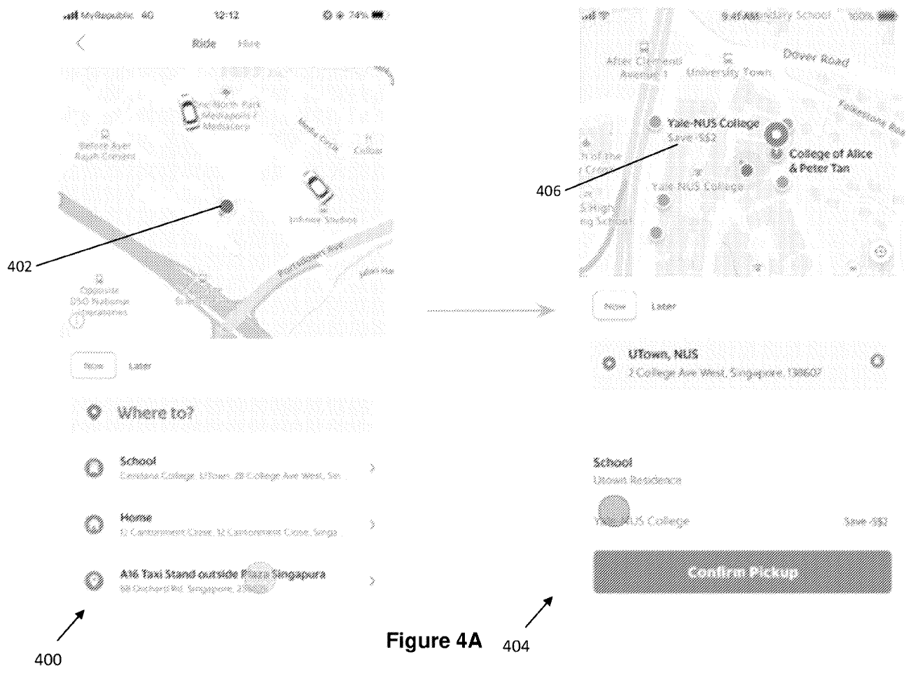

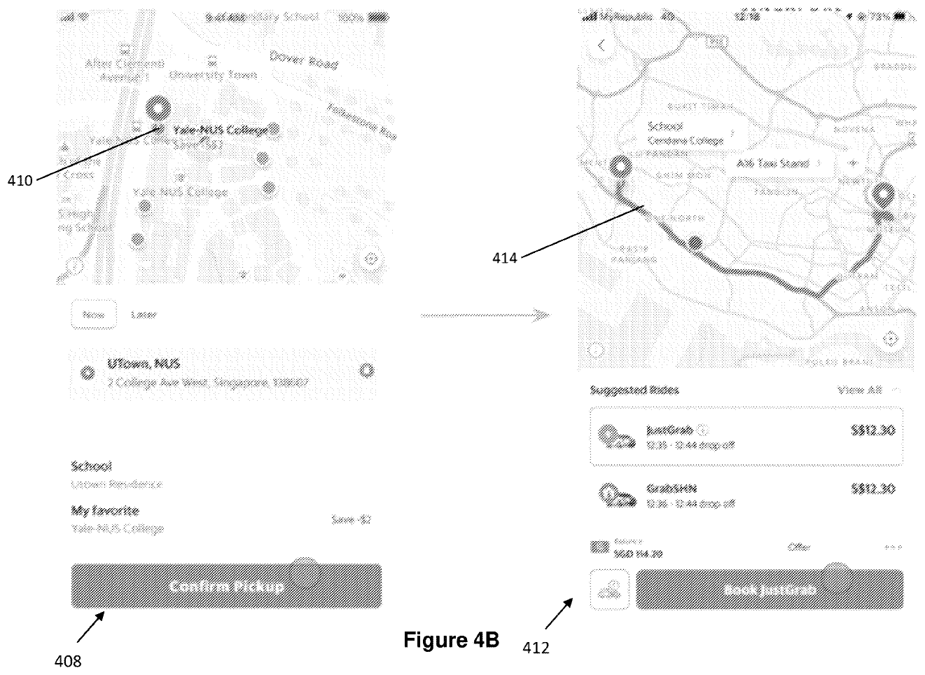

FIGS. 4A-B depict an example illustration of a user booking flow according to various embodiments. In this example, a user may indicate his current location 402 (e.g. automatically detected via GPS) as a starting location in a ride request. The user may also indicate a destination location in menu 400. Based on the starting location, one or more pick up points (e.g. determined by the route server 140) may be provided for selection by the user as shown in menu 404. Further, one or more pick up points may have corresponding text 406 informing of an estimated amount of cost savings that the user may enjoy if the corresponding pick up point is selected. The cost savings may be based on comparison of estimated prices of one or more routes that are determined by the route server 140 for each pick up point to the destination location. In an implementation, text indicating other factors like amount of time savings, walking distance, and other similar factors may also be displayed based on, for example, user preferences.

In a next menu 408, the user may select the pick up point 410 which may save him $2 as informed by the displayed text 406, and then confirms the pick up point. In a next menu 412, the user may check the displayed route 414 and corresponding price for the ride before confirming the ride booking.

Advantageously, the proposed solution may generate greater goodwill with users, leading to better Passenger Net Promoter score (PAX NPS) and platform retention. Consumers may also be more trusting towards the platform providing the ride, and lower prices or faster trips may also lead to higher levels of conversion wherein more people may use the platform for ride bookings instead of other rival platforms. Further, by nudging users to use the more efficient pick up and drop off points, the overall capacity of the platform can also be improved, leading to more revenue due to enhanced capacity to complete more rides in a shorter time.

To enable the proposed solution, new steps may be introduced into a typical booking flow. At the start of the booking flow, a user is typically asked to indicate his intended destination location. Given a selected destination location, the system would predict where the most likely pick up point the user would be. Today, the prediction is typically based on the user's GPS location and a historical understanding of pick up points frequently used by the user.

The proposed solution aims to not only predict the most likely pick up location but also compute feasible nearby pick up locations that a user could walk to, and an estimated price and time for each of these candidate pick up points (e.g. an estimated price and time for each of one or more routes from a pick up point to the destination location) that a user would incur if these alternative options were selected.

The set of feasible pick-up locations can be determined by, for example, looking at an internal geofence database which provides the geometric boundary of a building such as shopping centers or zones such as Gardens by the Bay. For example, such data may be stored in reference database 150. Pick up points within these geometric boundaries will highly likely be feasible for a user booking a ride from another pick up point within the same boundary to walk to. This may work best if these venues are indoors, as user location via GPS tends to be less accurate. However, where a user location can be known more precisely, estimated walking times can be computed to nearby pick up point in a more freeform way to determine pick up points that could be within reasonable walking distance (e.g. distance requiring an estimated walking time of 3 mins).

FIG. 5 depicts an example illustration of a flowchart 500 for adaptively identifying an optimal route according to various embodiments. At step 502, one or more pick up points are determined (e.g. by the routing server 140) based on a starting location indicated in a request for a ride. The starting location may also be a current GPS location of the user. POI storage 504 may be an internal memory of the POI module 262 or the route server 140, or it may be part of the reference database 150 or other similar forms of data storage. The POI storage 504 may be configured to store a plurality of all possible pick up points and drop off points, including one or more pick up points that are in proximity to the starting location. The system can thus query related pick up points based on starting location and the geometric information mentioned above with reference to the POI storage 504. Geometric indexing technique may be used to build the relationship of the starting location and candidate pick up points.

At step 506, an estimated walking time and distance from the starting location to each pick up point may be calculated. At step 508, alternative pick up points may be filtered, for example by using a maximal walking time and/or distance threshold. This threshold may be determined based on user preference or a default setting (e.g. a maximal walking time of 10 minutes). At step 510, an estimated travel time and distance from each pick up point to the destination location may be calculated. Steps 506-510 may be performed with reference to a route planning component 512. The route planning component 512 may be the routing module 264 or a part of the routing module 264, and/or may be a part of the route server 140. The route planning component 512 may be configured to calculate the estimated time and distance for walking and traveling based on a road network geometry graph. A shortest path technique may be used to get an optimal route and the distance on the route, and then a machine learning model based on real-time traffic speed may be used to estimate a corresponding travel time for each route.

At step 514, an estimated price for traveling from each pick point to the destination location may be calculated. The calculation may be based on a predefined traveling time and distance coefficient for each determined route from each pick up point to the destination location, and may account for road taxes or tolls such as, for example, when passing through an electronic road pricing (ERP) gantry. The calculation may be performed by a pricing calculator 516. The pricing calculator 516 may be the pricing module 266 or a part of the pricing module 266, and/or may be a part of the route server 140. At step 518, an optimal pick up point may be tagged (e.g. by displaying text informing of potential cost savings based on the calculations of estimated price, potential time savings based on the estimated traveling time and/or distance, shortest travel distance, shortest walking distance, and other similar factors). How an optimal pick up point is defined may depend on user preference, and settings for how the optimal pick up point is defined may be changed and configured by the user.

FIG. 6 depicts an example illustration of a system 600 that may be implemented for adaptively identifying an optimal route according to various embodiments. Overall, the system 600 may have multiple services including a POI service 604 to handle selection of POIs (e.g. pick up and drop off points) based on the starting and destination locations, a route engine service 606 to handle determination of routes between the starting location (or each pick up point) and destination location (or each drop off point) and then selection of an optimal route, and price service 608 to handle prices selection and computation. The system may further comprise a map source 610 such as, for example, Karta™ Map to provide POI data and routing information for the POI service 604 and the route engine service 606. Users' selections (e.g. input from user device 602), user preferences (e.g. stored in a Customer POI preference stream 612), and price saved information (e.g. stored in a price information stream 616) may be persisted to a data lake 614 for reference to ensure that the determination of an optimal route is consistent with preferences indicated by the user.

The system 600 may be configured to list a set of feasible pick up points based on a defined optimality criteria such as distance to the starting location, price and/or time required for getting from the pick up point to the starting location, the price and/or time for getting from the pick up point to the user selected destination location and/or drop off point/s, and other similar criteria. In order to minimize inconvenience to the user but also surface an alternative option of a cheaper or faster pick up point, the system 600 may rank the most likely selected (by the user) and most optimal pick up points and/or most optimal drop off points next to one another and display these options visibly on screen for the user to consider and make a selection. An additional tag may be added to the pick-up point (e.g. text 406 in FIG. 4A) to provide additional information to the user such as, for example, “Save—$2” to help the user make a more informed decision.

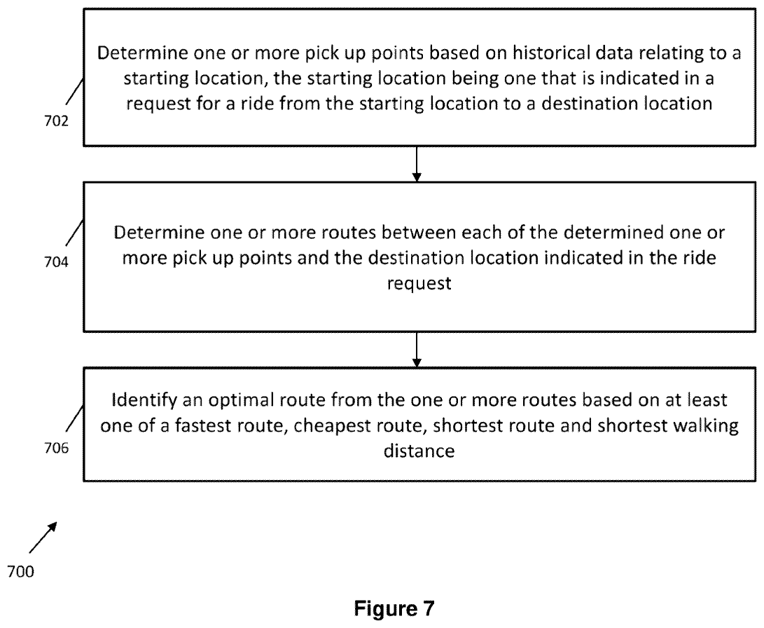

FIG. 7 illustrates an example flow diagram of a method for adaptively identifying an optimal route according to various embodiments. In a step 702, one or more pick up points are determined based on historical data relating to a starting location, the starting location being one that is indicated in a request for a ride from the starting location to a destination location. In a step 704, one or more routes between each of the determined one or more pick up points and the destination location indicated in the ride request are determined. In a step 706, an optimal route is identified from the one or more routes based on at least one of a fastest route, cheapest route, shortest route and shortest walking distance.

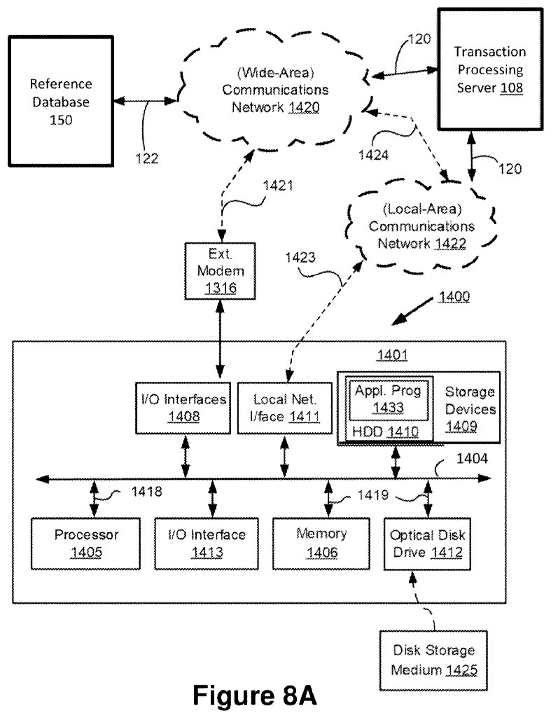

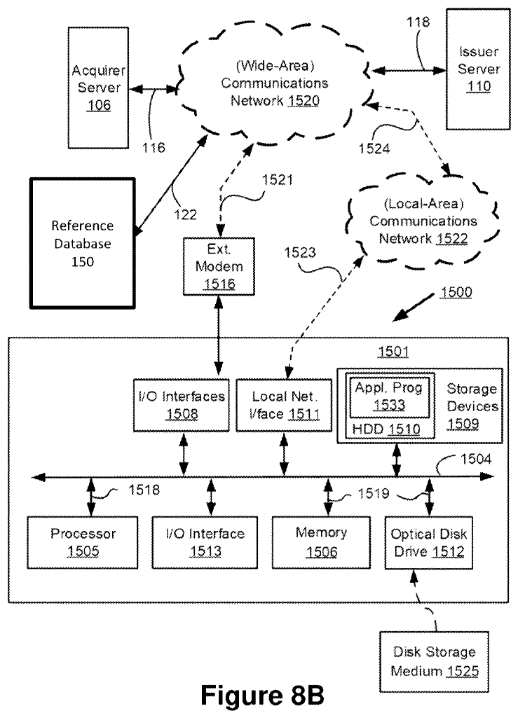

FIG. 8A depict an example computer system 1400, in accordance with which the route server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 8A, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1304 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 700, where performed by the route server 140 may be implemented using the computer system 1400. The processes may be implemented as one or more software application programs 1433 executable within the computer system 1400. In particular, the sub-processes 400, 500, and 600 are effected by instructions in the software 1433 that are carried out within the computer system 1400. The software instructions may be formed as one or more code modules, each for performing one or more particular tasks. The software may also be divided into two separate parts, in which a first part and the corresponding code modules performs the method 700 and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for a route server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a route server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the route server 140) is presented merely by way of example. Therefore, in some arrangements, one or more features of the computer system 1400 may be omitted. Also, in some arrangements, one or more features of the computer system 1400 may be combined together. Additionally, in some arrangements, one or more features of the computer system 1400 may be split into one or more component parts.

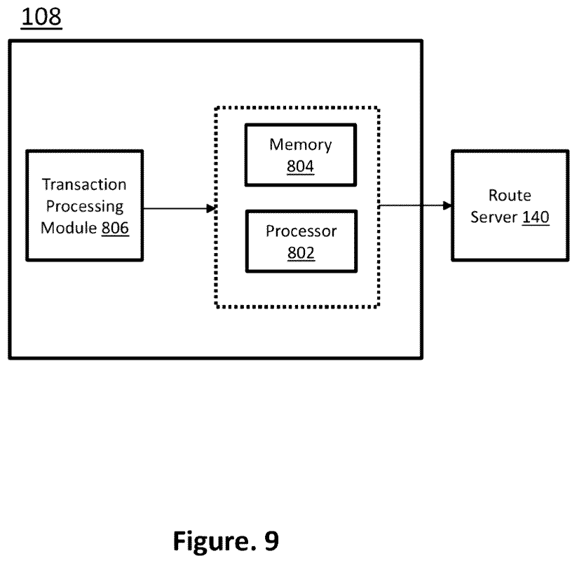

FIG. 9 shows an implementation of the transaction processing server 108 (i.e., the computer system 1300). In this implementation, the transaction processing 108 may be generally described as a physical device comprising at least one processor 802 and at least one memory 804 including computer program codes. The at least one memory 804 and the computer program codes are configured to, with the at least one processor 802, cause the transaction processing server 108 to facilitate the operations described in method 700. The transaction processing server 108 may also include a transaction processing module 806. The memory 804 stores computer program code that the processor 802 compiles to have transaction processing module 806 perform the respective functions.

With reference to FIG. 1, the transaction processing module 806 performs the function of communicating with the requestor device 102 and the provider device 104; and the acquirer server 106 and the issuer server 110 to respectively receive and transmit a transaction, a request for a ride, or other similar messages. The transaction processing module 806 may be configured to process processes relating to a transaction account by, for example, forwarding data and information associated with the transaction to the other servers in the system 100 such as the route server 140. In an example, the transaction processing module 806 may, instead of the requestor device 102, transmit data relating to a request message such as a request for a ride (e.g. date, time, a starting location, a destination location, and other similar data) to the route server 104. The transaction processing module 806 may use a variety of different protocols and procedures in order to process the payment and/or travel co-ordination requests.

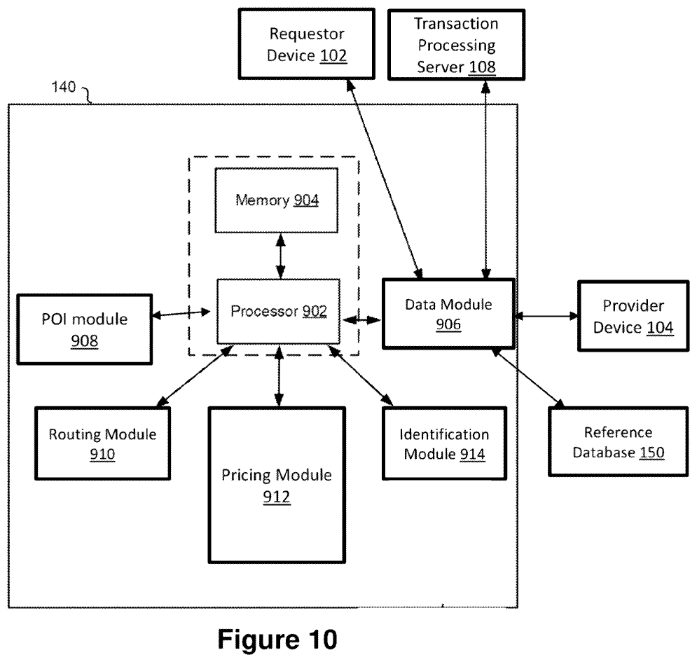

FIG. 10 shows an alternative implementation of the route server 140 (i.e., the computer system 1400). In the alternative implementation, route server 140 may be generally described as a physical device comprising at least one processor 902 and at least one memory 904 including computer program codes. The at least one memory 904 and the computer program codes are configured to, with the at least one processor 902, cause the route server 140 to perform the operations described in the method 700. The route server 140 may also include a data module 906, a POI module 908, a routing module 910, a pricing module 912 and an identification module 914. The memory 904 stores computer program code that the processor 902 compiles to have each of the modules 906 to 914 performs their respective functions.

With reference to FIGS. 1 to 7, the POI module 908 performs the function of determining one or more pick up points based on historical data relating to a starting location, the starting location being one that is indicated in a request for a ride from the starting location to a destination location.

With reference to FIGS. 1 to 7, the routing module 910 performs the function of determining one or more routes between each of the determined one or more pick up points and the destination location indicated in the ride request.

With reference to FIGS. 1 to 7, the pricing module 912 performs the function of calculating an estimated price for a ride from each of the one or more pick up points to the destination location.

With reference to FIGS. 1 to 7, the identification module 914 performs the function of adaptively identifying an optimal route from the one or more routes based on at least one of a cheapest route, fastest route, shortest route and shortest walking distance.

In an implementation, the historical data may be stored in the reference database 150. The historical data may indicate a plurality of pick up points and location information for each of the plurality of pick up points, and the POI module 908 may be further configured to select, from the plurality of pick up points, one or more pick up points that are in proximity to the starting location based on the location information.

In an implementation, determining the one or more routes by the routing module 910 may further comprise calculating a first set of estimated time and distance for walking from the starting location to each of the one or more pick up points, and a second set of estimated time and distance for a ride from each of the one or more pick up points to the destination location.

In an implementation, the historical data may further indicate a plurality of drop off points and location information for each of the plurality of drop off points, and the POI module 908 may be further configured to determine one or more drop off points that are in proximity to the destination location based on the location information. The routing module 910 may be further configured to determine the one or more routes comprising one or more routes between each of the determined one or more pick up points and each of the one or more determined drop off points, and calculate the second set of estimated time and distance based on a ride from each of the one or more pick up points to each of the one or more determined drop off points.

In an implementation, identifying an optimal route by the identification module 914 may further comprise identifying a route from the one or more routes with a shortest time or distance as the optimal route based on the first and/or second sets of estimated times and distances.

In an implementation, determining the one or more routes by the routing module 910 may further comprise calculating a third set of estimated time and distance for walking from each of the one or more drop off points to the destination location, and identifying an optimal route by the identification module 914 may further comprise identifying a route from the one or more routes with a shortest time or distance as the optimal route based on the first, second and/or third sets of estimated times and distances.

In an implementation, determining the one or more routes by the routing module 910 may further comprise calculating an estimated price for a ride from each of the one or more pick up points to the destination location by the pricing module 912, and identifying an optimal route by the identification module 914 may further comprise identifying a route from the one or more routes with a cheapest price as the optimal route based on the estimated prices.

With reference to FIGS. 1 to 7, the data module 906 performs the functions of receiving data and information from the requestor device 102, provider device 104, transaction processing server 108, reference database 150, a cloud and other sources of information to facilitate the method 700. For example, the data module 906 may be configured to receive data and information required for processing the request for adaptively identifying an optimal route from the requestor device 102, the provider device 104, transaction processing server 108, reference database 150, and/or other sources of information. The data module 906 may also be configured to retrieve data required by the request from the reference database 150, other databases that may be designated by the request for data, and/or other sources of information. The data module 906 may be further configured to send information relating to data retrieved in response to the request to the requestor device 102, the provider device 104, the transaction processing server 108, or other destinations where the information is required. The data module 906 may be further configured to communicate with and store data and information for each of the POI module 908, routing module 910, pricing module 912 and identification module 914. Alternatively, all the tasks and functions required for facilitating the method 700 may be performed by a single processor 902 of the route server 140.

FIG. 8B depicts a general-purpose computer system 1500, upon which a combined transaction processing server 108 and route server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 8D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 700 performed by the route server 140 and facilitated by the transaction processing server 108 may be implemented using the computer system 1500. For example, the steps of the method 700 as performed by the route server 140 may be implemented as one or more software application programs 1533 executable within the computer system 1500. In particular, the steps of the method 700 are effected by instructions in the software 1533 that are carried out within the computer system 1500. The software instructions may be formed as one or more code modules, each for performing one or more particular tasks. The software may also be divided into two separate parts, in which a first part and the corresponding code modules performs the steps of the method 700 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined transaction processing and route server.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined transaction processing and route server.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (i.e., combined transaction processing and route server 1500) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

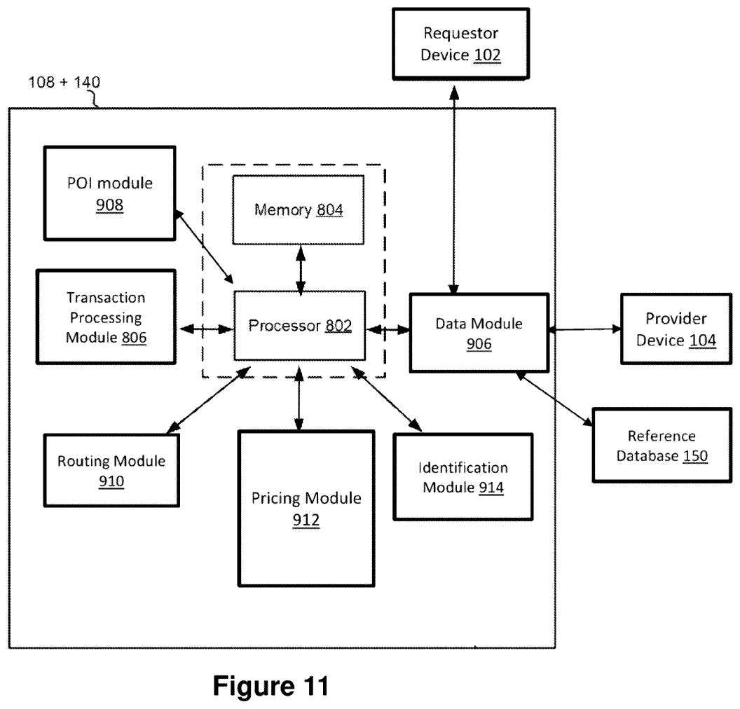

FIG. 11 shows an alternative implementation of combined transaction processing and route server (i.e., the computer system 1500). In the alternative implementation, the combined transaction processing and route server may be generally described as a physical device comprising at least one processor 1002 and at least one memory 904 including computer program codes. The at least one memory 1004 and the computer program codes are configured to, with the at least one processor 1002, cause the combined transaction processing and route server to perform the operations described in the steps of the method 700. The combined transaction processing and route server may also include a transaction processing module 806, a data module 906, a POI module 908, a routing module 910, a pricing module 912 and an identification module 914. The memory 1004 stores computer program code that the processor 1002 compiles to have each of the modules 806 to 912 performs their respective functions. The transaction processing module 806 performs the same functions as described for the same transaction processing module in FIG. 9. The data module 906, POI module 908, routing module 910, pricing module 912 and identification module 914 perform the same functions as described for the same corresponding modules in FIG. 10.

It will be appreciated by a person skilled in the art that numerous variations and/or modifications may be made to the present disclosure as shown in the specific embodiments without departing from the scope of the specification as broadly described. The present embodiments are, therefore, to be considered in all respects to be illustrative and not restrictive.

1. A method for adaptively identifying an optimal route, comprising:
determining, by a processor, one or more pick up points based on historical data relating to a starting location, the starting location being one that is indicated in a request for a ride from the starting location to a destination location;
determining, by the processor, one or more routes between each of the determined one or more pick up points and the destination location indicated in the ride request; and adaptively identifying, by the processor, an optimal route from the one or more routes based on at least one of a cheapest route, fastest route, shortest route and shortest walking distance.

2. The method of claim 1, wherein the historical data indicates a plurality of pick up points and location information for each of the plurality of pick up points, and determining the one or more pick up points further comprises selecting, from the plurality of pick up points, one or more pick up points that are in proximity to the starting location based on the location information.

3. The method of claim 1, wherein determining the one or more routes further comprises calculating a first set of estimated time and distance for walking from the starting location to each of the one or more pick up points, and a second set of estimated time and distance for a ride from each of the one or more pick up points to the destination location.

4. The method of claim 3, wherein the historical data indicates a plurality of drop off points and location information for each of the plurality of drop off points, and determining the one or more routes further comprises:
determining one or more drop off points that are in proximity to the destination location based on the location information,
determining the one or more routes comprising one or more routes between each of the determined one or more pick up points and each of the one or more determined drop off points; and
calculating the second set of estimated time and distance based on a ride from each of the one or more pick up points to each of the one or more determined drop off points.

5. The method of claim 3, wherein identifying an optimal route further comprises identifying a route from the one or more routes with a shortest time or distance as the optimal route based on the first and/or second sets of estimated times and distances.

6. The method of claim 4, wherein determining the one or more routes further comprises calculating a third set of estimated time and distance for walking from each of the one or more drop off points to the destination location, and identifying an optimal route further comprises identifying a route from the one or more routes with a shortest time or distance as the optimal route based on the first, second and/or third sets of estimated times and distances.

7. The method of claim 1, wherein determining the one or more routes further comprises calculating an estimated price for a ride from each of the one or more pick up points to the destination location, and identifying an optimal route further comprises identifying a route from the one or more routes with a cheapest price as the optimal route based on the estimated prices.

8. A system for adaptively identifying an optimal route, the system comprising: at least one processor; and
at least one memory including computer program code;
the at least one memory and the computer program code configured to, with the at least one processor, cause the system at least to:
determine one or more pick up points based on historical data relating to a starting location, the starting location being one that is indicated in a request for a ride from the starting location to a destination location;
determine one or more routes between each of the determined one or more pick up points and the destination location indicated in the ride request; and
adaptively identify an optimal route from the one or more routes based on at least one of a cheapest route, fastest route, shortest route and shortest walking distance.

9. The system of claim 8, wherein the historical data indicates a plurality of pick up points and location information for each of the plurality of pick up points, and determining the one or more pick up points further comprises selecting, from the plurality of pick up points, one or more pick up points that are in proximity to the starting location based on the location information.

10. The system of claim 8, wherein determining the one or more routes further comprises calculating a first set of estimated time and distance for walking from the starting location to each of the one or more pick up points, and a second set of estimated time and distance for a ride from each of the one or more pick up points to the destination location.

11. The system of claim 10, wherein the historical data indicates a plurality of drop off points and location information for each of the plurality of drop off points, and determining the one or more routes further comprises:
determining one or more drop off points that are in proximity to the destination location based on the location information, determining the one or more routes comprising one or more routes between each of the determined one or more pick up points and each of the one or more determined drop off points; and
calculating the second set of estimated time and distance based on a ride from each of the one or more pick up points to each of the one or more determined drop off points.

12. The system of claim 10, wherein identifying an optimal route further comprises identifying a route from the one or more routes with a shortest time or distance as the optimal route based on the first and/or second sets of estimated times and distances.

13. The system of claim 11, wherein determining the one or more routes further comprises calculating a third set of estimated time and distance for walking from each of the one or more drop off points to the destination location, and identifying an optimal route further comprises identifying a route from the one or more routes with a shortest time or distance as the optimal route based on the first, second and/or third sets of estimated times and distances.

14. The system of claim 8, wherein determining the one or more routes further comprises calculating an estimated price for a ride from each of the one or more pick up points to the destination location, and identifying an optimal route further comprises identifying a route from the one or more routes with a cheapest price as the optimal route based on the estimated prices.
